(19) United States
(12) Patent Application Publication
(10) Pub. No.: US 2016/0156775 A1
(43) Pub. Date: Jun. 2, 2016

(54) PRE-UNLOCK LOCAL PUSH INTERACTION FOR NON-NATIVE TELEPHONY SERVICE

(71) Applicant: Vonage Netowrk, LLC, Holmdel, NJ (US)

(72) Inventors: Tali WAISEL, Ganey Tikva (IL); Natan SHALTIEL, Tel Aviv (IL); Sagi DUDAI, Tel Aviv (IL); Gil OSHER, Rehovot (IL)

(21) Appl. No.: 14/558,421

(22) Filed: Dec. 2, 2014

(51) Int. Cl. H04M 1/725; H04W 68/00

(52) U.S. Cl. CPC H04M 1/72577; H04M 1/72522; H04W 68/005

(57) ABSTRACT

A telephony device and method of operating the telephony device generates local push notifications. The method comprises receiving from a network a notification of an incoming call carried by a non-native telephony service. In conjunction with the incoming call a push notification is provided on a user interface while the telephony device is subject to a security lock. The push notification is configured to prompt a first user response input through the user interface. Upon receipt of an appropriate first user response input, a telephony connection carried by the non-native telephony service is completed while the telephony device is still subject to the security lock.

### TECHNICAL FIELD

The technology relates to telecommunications, and particularly to telecommunications involving wireless telephony devices.

### BACKGROUND

A telephone subscriber generally has one or more telephony devices which are served by a home carrier and which are associated with a nominal telephone number, such as a directory number. Telephonic communications emanating or originating from a telephony device of the subscriber as a calling party (e.g., outgoing communications) are generally routed by the calling party's home carrier through one or more switches, and possibly networks of other carriers, to a called party. The called party may be a subscriber of the same or of another home carrier. Conversely, telephonic communications destined for the telephony device of the called telephone subscriber (e.g., incoming communications) are routed on the basis of, e.g., the nominal telephone number, through switches to the called party's home carrier so that the communications may be “terminated” at the called party, i.e., the telephone subscriber.

In some instances in which the telephony device is an analogue device, the communications involving the telephone subscriber may be initiated as analogue communications and thereafter may be adapted for packet transmission. In other cases the telephony device may be a data packet-compatible device, such as an Internet Protocol (IP) device, so that the communication is essentially entirely packet-based. In either case, Internet Protocol telephony systems have been provided to route various types of communications, at least in part, via data packets that are communicated over a data network. The data network is commonly the Internet. The types of communications may be, for example, telephone calls, video calls, text and video messages, and other forms of telephony and data communications.

In some instances an outgoing communication may be routed at the subscriber's request to the Internet Protocol telephony system, so that the communications may be completed or “terminated” by the Internet Protocol telephony system. Some users or subscribers of the IP telephony system may engage in communications using telephony devices that are connected by physical lines such as cables or wires to an access point such as an internet port. Such wired telephony devices may, thanks to the services of the IP telephony system, be moved from one physical location to another physical location, but at each such physical location are physically connected in wired manner to the respective access point.

Other users or subscribers of the IP telephony system may possess mobile or wireless telephony devices, such as a wireless terminal, user equipment (UE), mobile phone, smart phone, or laptop, tablet, or other device with mobile termination. Nowadays some telephony services including IP telephony systems provide computerized applications that may be downloaded to a mobile telephony device. Upon login to such mobile telephony applications (e.g., with user name and password) the mobile telephony device user may at least temporarily register the mobile telephony device with the Internet Protocol telephony system.

When a network directs a call to the telephony device, the call is routed from the network to the telephony device by direct signaling in the form of a network event (such as a Session Initiation Protocol [SIP] Invite) or by a push notification.

Push communications, e.g., push notifications, enable a client application resident on a telephony device to notify a user of new messages or events even when the user is not actively using the client application. That is, a push notification allows a client application to notify the user of new messages or events without the need to actually open the client application. Push notifications are facilitated by a push notification service, which typically is a third party service that is generally not directly connected with a telephony service provider. A push notification service provides a channel through which a push notification may be sent from an application on a server to the client application on the telephony device. Example push notification services are Apple® Push Notification Service [APNs] on Apple® telephony devices and Goggle® Cloud Messaging [GCM] on Google®/Android™ telephony devices. If a notification for a client software application arrives when that client application is not running on the telephony device, the APNS and GSM services allow the telephony device to alert the user that the client application has data waiting for it. In other words, when new data for a client application arrives, a notification is sent through the channel to the APNS or GCM service, which pushes the notification to the target telephony device. Push notifications may be used for various purposes, such as reaching a communications software application installed on a telephony device in a situation in which an IP telephony system may otherwise have difficulty, as described, e.g., in U.S. patent application Ser. No. 13/190,698 filed Jul. 26, 2011, entitled “METHOD AND APPARATUS FOR VOIP COMMUNICATION COMPLETION TO A MOBILE DEVICE”; U.S. patent application Ser. No. 13/940,647, filed Jul. 12, 2013, entitled “Method and Apparatus for VoIP Communication Completion to a Mobile Device”; and U.S. patent application Ser. No. 13/940,804, filed Jul. 12, 2013, entitled “Method and Apparatus for VoIP Communication Completion to a Mobile Device”, both of which are incorporated herein by reference in their entirety.

In general push notifications may be classified as public or private. A private push notification generally provides some form of alert to the user upon arrival of the push notification, e.g., a banner or notification message that may require further interaction from the user before the application to which the push notification is directed is given central processing (CPU) time. A second type of push notification is a private notification, in which the user is not provided with an alert but instead the push notification is essentially transparently (to the user) and automatically (without user intervention or approval or input) directed by the operating system to the particular application to which the push notification pertains. The Apple i057 operating system is an example of an operating system that facilitates private push notifications.

A telephony device comprises a processor or processor system that executes an operating system. When the operating system has control of the processor, the operating system may allow execution of other executable programs, some of which may be executable application programs provided by various vendors. Some of the executable application programs are pre-installed on the telephony device, such as the native telephony service which is typically sold along with the telephony device. Such pre-installed executable applications are often called native executable applications. Others of the executable application programs, known as “over-the-top” (OTT) programs are typically selected and installed by the user after sale of the telephony device. Many users have found advantage in installing a OTT applications program of a telephony service other than that which is native to the telephony device, e.g., a non-native telephony service. In particular, executable applications for non-native Internet telephony systems such as those which provide the services described above are especially popular.

Additionally, telephony devices typically have a security feature, e.g., a security lock, intended to prevent unauthorized users from gaining access to services provided through the telephony device. In some telephony devices the security feature is a passcode that must be entered before the user can engage in substantive use of the telephony device. For example, the passcode may be four digits that must be entered on a keypad displayed by the operating system before services of the operating system or other executable application programs (such as OTT applications) can be launched or provided. In some telephony devices the security entry may be detection of an attribute of a registered user, such as a fingerprint or thumbprint, for example.

Currently when a telephony device is locked and a user receives a call on a telephony device that is carried by a non-native telephony service, a remote push communication (essentially of the type described above) is received externally from a network, e.g., from a push server. A remote push notification associated with the remote push communication is displayed by the operating system as a small notification or banner on a display screen of a user interface. The only way in which the executable application for the non-native telephony service can interact with the user is for the user to swipe the display screen that bears the remote push notification, and thereafter (in response to a displayed prompt) enter the passcode or satisfy other security detection features. Only then is the executable application for the non-native telephony service “launched” in a way that it can both answer the incoming call and have further interaction with the user through the user interface.

Unfortunately, it takes time and some mental effort both to swipe the remote push notification and then enter the passcode before gaining access to a non-native telephony service. This is a problem if there is only a very limited time to answer a call before it times out, and it is extremely cumbersome to swipe to answer and then type in the password to unlock before being able to actually answer an incoming call. Without removal of the security lock, e.g., without entry of the passcode, the executable application of the non-native telephony service is not able to gain access to the user interface, and therefore cannot show to the user the screen displays that allow the user to interact with the non-native telephony service.

Some manufacturers of telephony devices embed or pre-program into the operating system a special privilege for a native executable application to gain limited access of the user interface. With this special privilege the native executable application may, on a limited basis, present screen displays on the user interface or even execute the full blown native executable application without the need to unlock the device and still without compromising security. Such special privileges typically extend to the native camera application, the native alarm application, and the native phone application. This special privilege enables the native applications to provide the “complete” user experience without compromising the user's privacy/security. For the native phone application, for example, this means that when a users receives a call, the user is presented with the full “call screen” on the user interface without unlocking. However, if the user then exits the native executable application, e.g., by using the home button on the keypad, the user is presented with the security screen, thereby trying to keep the telephony device secure.

What is needed therefore, and an objective and advantage of the technology disclosed herein, are apparatus, method, and technique for enabling use of a non-native executable application prior to release of a security lock.

### SUMMARY

In one of its aspects the technology disclosed herein concerns a telephony device comprising a user interface and a processor. The processor is configured to generate, on the user interface, plural user interface displays which provide user output information and through which user input is received by the processor. The processor is further configured to provide a push notification to be displayed on the user interface upon receipt of an indication of an incoming telephony event carried by a non-native telephony service and while the telephony device is subject to a security lock, the push notification being configured to prompt a first user response input through the user interface. The processor is further configured, upon receipt of an appropriate first user response input, to complete a telephony connection carried by the non-native telephony service while the telephony device is still subject to the security lock.

In an example embodiment and mode the processor is further configured to generate the push notification as a local push notification to be displayed on the user interface while the telephony device is still subject to the security lock.

In an example embodiment and mode the user interface comprises a display screen, and the local push notification visually occupies a minor portion of the display screen.

In an example embodiment and mode the local push notification is configured to provide one of a call waiting notification and a missed call notification.

In an example embodiment and mode the local push notification is configured to facilitate entry of further user input response while the telephony device is still subject to the security lock.

In an example embodiment and mode the processor is configured, upon receipt of the appropriate first user response input, to execute pre-unlock coded instructions comprising a non-native telephony service executable application, the pre-unlock instructions being configured to generate said local push notification.

In an example embodiment and mode the processor is configured to execute an operating system and a non-native telephony service executable application. The operating system and the non-native telephony service executable application compriserespective executable instructions stored on a non-transient computer-readable medium. The operating system comprises an operating system/user interface through which the remote push notification and a native telephony service application have access to the user interface; and, an operating system/application interface to the non-native telephony service executable application and through which the non-native telephony service executable application has non-direct access to the user interface a user interface. The non-native telephony service executable application comprises a set of pre-unlock coded instructions configured to generate, through the operating system/application interface and then through the operating system/user interface, one or more local push notifications on the user interface while the telephony device is still subject to the security lock.

In an example embodiment and mode the local push notification is displayed on a display screen of the user interface over a minor portion of a screen display generated by the operating system.

In an example embodiment and mode the non-native telephony service executable application further comprises a set of post-unlock coded instructions configured to generate, through the application interface and through the operating system interface, one or more screen displays associated with execution of the non-native telephony service executable application while the telephony device is not subject to the security lock.

In an example embodiment and mode the user interface comprises a display screen, wherein the local push notification visually occupies a minor portion of the display screen; and wherein the one or more screen displays associated with the execution of the non-native telephony service executable application visually occupy a preponderance of the display screen.

In another of its aspects the technology disclosed herein concerns a method in a telephony device. The method comprises receiving from a network a notification of an incoming call carried by a non-native telephony service; in conjunction with the incoming call providing a push notification on a user interface while the telephony device is subject to a security lock, the push notification being configured to prompt a first user response input through the user interface; and, upon receipt of an appropriate first user response input, completing a telephony connection carried by the non-native telephony service while the telephony device is still subject to the security lock.

In an example embodiment and mode the method further comprises the generating the push notification as a local push notification to be displayed on the user interface while the telephony device is still subject to the security lock.

In an example embodiment and mode the user interface comprises a display screen, and the local push notification visually occupies a minor portion of the display screen.

In an example embodiment and mode the method further comprises configuring the local push notification to provide one of a call waiting notification and a missed call notification.

In an example embodiment and mode the method further comprises receiving a further user input response local push notification while the telephony device is still subject to the security lock.

In an example embodiment and mode the method further comprises, upon receipt of the first user response input, generating one or more local push notifications while the telephony device is still subject to the security lock.

In an example embodiment and mode the method further comprises executing an operating system and a non-native telephony service executable application using a processor, the operating system and the non-native telephony service executable application comprising respective executable instructions stored on a non-transient computer-readable medium. The operating system provides direct access to the user interface for the remote push notification and a native telephony service application. The operating system provides non-direct access for the non-native telephony service executable application to the user interface through an operating system/application interface. The non-native telephony service is an executable application generating or more local push notifications on the user interface using the operating system/application interface while the telephony device is still subject to the security lock.

In an example embodiment and mode the method further comprises displaying the local push notification on a display screen of the user interface over a minor portion of a screen display generated by the operating system.

In an example embodiment and mode the method further comprises receiving an unlock user entry; and then the non-native telephony service executable application executing a set of post-unlock coded instructions configured to generate, through the application interface and through the operating system interface, one or more screen displays associated with execution of the non-native telephony service executable application while the telephony device is not subject to the security lock.

In an example embodiment and mode the user interface comprises a display screen, and the local push notification visually occupies a minor portion of the display screen. The or more screen displays associated with the execution of the non-native telephony service executable application visually occupy a preponderance of the display screen.

In another of its aspects the technology disclosed herein concerns a computer program product comprising instructions stored on a non-transient memory which, when executed by a processor of a telephony device, result in performance of the various acts. Such acts include receiving an indication from an operating system of the telephony device of receipt of a first user response input to a push notification provided on a user interface of the telephony device while the telephony device is subject to a security lock; and in accordance therewith completing a telephony connection carried by the non-native telephony service while the telephony device is still subject to the security lock.

In an example embodiment and mode the computer program product comprises instructions stored on the non-transient memory which, when executed by the processor of the telephony device, generate the push notification as a local push notification to be displayed on the user interface while the telephony device is still subject to the security lock.

In an example embodiment and mode the user interface comprises a display screen, and the local push notification visually occupies a minor portion of the display screen.

In an example embodiment and mode the computer program product comprises instructions which, when executed by the processor of the telephony device, configure the local push notification as one of a call waiting notification and a missed call notification.

In an example embodiment and mode the computer program product comprises instructions which, when executed by the processor of the telephony device, configure the local push notification to facilitate entry of further user input response while the telephony device is still subject to the security lock.

In an example embodiment and mode the computer program product comprises instructions which, when executed by the processor of the telephony device, generate, through an operating system/application interface and then through an operating system/user interface, one or more local push notifications on the user interface while the telephony device is still subject to the security lock.

In an example embodiment and mode the computer program product comprises instructions which, when executed by the processor of the telephony device, display the local push notification on a display screen of the user interface over a minor portion of a screen display generated by the operating system.

In an example embodiment and mode the computer program further comprises a set of post-unlock coded instructions stored on the non-transient memory which, when executed by the processor of the telephony device, generate, through an operating system/application interface and through an operating system/user interface, one or more screen displays associated with execution of the non-native telephony service executable application while the telephony device is not subject to the security lock.

In an example embodiment and mode the user interface comprises a display screen, the local push notification visually occupies a minor portion of the display screen; and the one or more screen displays associated with the execution of the non-native telephony service executable application visually occupy a preponderance of the display screen.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a diagrammatic view of an exemplary communications environment, including various elements which are associated with an Internet protocol (IP) telephony system, which service a telephony device operating within coverage of the Internet protocol (IP) telephony system in accordance with an exemplary embodiment and mode.

FIG. 2 is a schematic view illustrating example functionalities and or units comprising a non-limiting exemplary embodiment of a telephony device having pre-unlock local push notification/processing for a non-native executable application according to an exemplary embodiment.

FIG. 3 is a schematic view illustrating example functionalities and or units comprising a non-limiting exemplary, more detailed embodiment of a telephony device according to FIG. 2, and further depicting various acts performed thereby.

FIG. 4 is a flowchart illustrating example, representative, non-limiting basic acts or steps that may be executed by a telephony device according to an example embodiment and mode of the technology disclosed herein.

FIG. 5A-FIG. 5E are diagrammatic views depicting example operating system screen displays upon which example respective push notifications are provided.

FIG. 6 is a flowchart illustrating example, representative, non-limiting basic acts or steps that may be performed in conjunction with execution of instructions comprising a computer program for a non-native telephony service.

FIG. 7 is a schematic view showing an example of machine hardware comprising one or more processors for implementing aspects of a wireless telephony device according to exemplary embodiments.

### DETAILED DESCRIPTION

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

In the following description, the terms “VoIP system,” “VoIP telephony system,” “IP system” and “IP telephony system” are all intended to refer to a system that connects callers and that delivers data, text and video communications using Internet Protocol data communications.

The following description will refer to “telephony communications.” The term “telephony communications” is intended to encompass any type of communication that could pass back and forth between users of an IP telephony system. This includes audio and video telephone, text messages, video messages and any other form of telephony or data communication.

In the following description, references will be made to an “IP telephony device.” This term is used to refer to any type of device which is capable of interacting with an IP telephony system to complete an audio or video telephone call or to send and receive text messages, and other forms of communications. An IP telephony device could be an IP telephone, a computer running IP telephony software, a telephone adapter which is itself connected to a normal analog telephone, or some other type of device capable of communicating via data packets. An IP telephony device could also be a cellular telephone or a portable computing device that runs a software application that enables the device to act as an IP telephone. Thus, a single device might be capable of operating as both a cellular telephone and an IP telephone.

The following description will also refer to a mobile telephony device. The term “mobile telephony device” is intended to encompass multiple different types of devices. In some instances, a mobile telephony device could be a cellular telephone. In other instances, a mobile telephony device may be a mobile computing device that includes both cellular telephone capabilities and a wireless data transceiver that can establish a wireless data connection to a data network. Such a mobile computing device could run appropriate application software to conduct VoIP telephone calls via a wireless data connection. Thus, a mobile computing device, such as an Apple iPhone™, a RIM Blackberry or a comparable device running Google's Android operating system could be a mobile telephony device.

In still other instances, a mobile telephony device may be a device that is not traditionally used as a telephony device, but which includes a wireless data transceiver that can establish a wireless data connection to a data network. Examples of such devices include the Apple iPod TouchTM and the iPadTM. Such a device may act as a mobile telephony device once it is configured with appropriate application software.

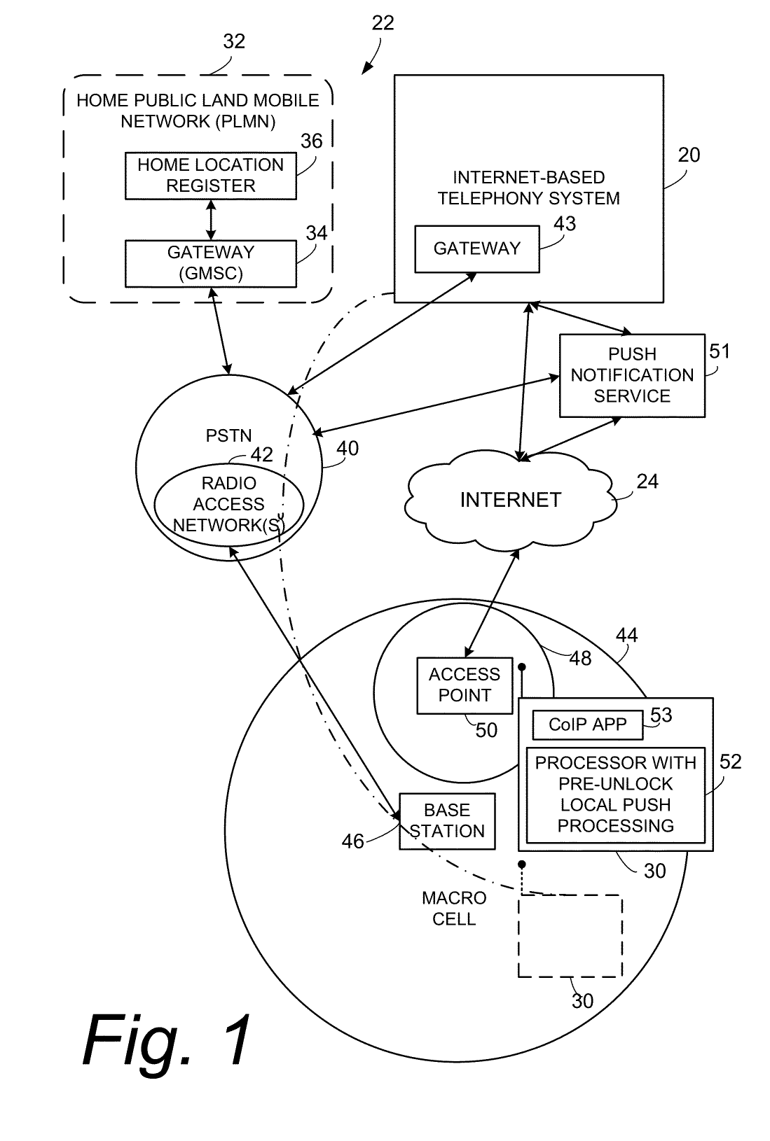

FIG. 1 shows a telephony system 20, in context of an exemplary generic communications system 22. In view of the fact that the telephony system 20 may be an Internet (IP) telephony system, the telephony system 20 is shown as connected to a data communications network such as Internet 24. A telephony device 30, which for sake of illustration happens to be a mobile or wireless telephony device such as a user equipment unit, smart phone, or laptop with mobile termination, for example, is associated with a customer of the telephony system 20.

The customer is not only a customer of telephony system 20, but is also served by the customer's home public land mobile network (PLMN) 32. The customer's home public land mobile network 32 is shown in FIG. 1 as comprising a PLMN gateway or switching center (GMSC) 34, as well as a PLMN home location register (HLR) 36. In this respect, the customer's home public land mobile network (PLMN) 32 or another telephone system may be considered as a “native” or first telephony system for the customer, while the telephony system 20 may be considered a “non-native” or second telephony system for the customer. In this regard, see, e.g., U.S. Pat. No. 8,265,083, incorporated herein by reference.

Both home public land mobile network 32 and telephony system 20 are connected to the public switched telephone network (PSTN) 40. The public switched telephone network (PSTN) 40 may comprise one or more radio access network(s) (RANs) 42. The home public land mobile network 32 is connected to public switched telephone network (PSTN) 40 through the PLMN gateway 34. Telephony system 20 is also connected to public switched telephone network (PSTN) 40 through its gateway(s) 43.

FIG. 1 further shows telephony device 30 as being situated in a radio access network cell 44 which is served by base station 46 of a radio access network 42. The base station 46 may be a base station controller (BSC), NodeB, eNodeB, or other type of base station. As such, the network cell 44 may be referred to as a macro cell and the base station 46 as a macro base station. Typically macro base stations such as macro base station 46 communicate with wireless terminals using licensed frequencies.

It will be appreciated that some macro base stations belong to networks which have data connection handling capability while other base stations belong to networks that do not have data connection handling capability. The former networks provide services such as call service and short message service (SMS), and typically include base stations which report to a radio network controller node and which may belong to a roaming area. The former networks additionally provide General Packet Radio Service (GPRS)/3G/LTE services and typically include base stations characterized as NodeB or eNodeB and for which routing areas are defined. The base stations of both types of networks broadcast their roaming and routing area.

FIG. 1 also shows telephony device 30 as being within a smaller cell 48 (e.g., a micro cell, home cell, pico cell, or femto cell) which is served by a wireless access point 50 of an internet-connected wireless access service. The access point 50 may provide Wi-Fi or WiMAX access to telephony device 30. Wi-Fi is a technology that allows an electronic device to exchange data or connect to the Internet wirelessly using microwaves in the 2.4 GHz and 5 GHz bands, and thus includes any “wireless local area network (WLAN) products that are based on the Institute of Electrical and Electronics Engineers' (IEEE) 802.11 standards”. The smaller cell 48 may also be referred to as an access point cell. Typically access points such as access point 50 communicate with wireless terminals using unlicensed frequencies. Thus, in the FIG. 1 situation, the telephony device 30 has a data connection through wireless access point 50 to the internet telephony service 20.

FIG. 1 also shows by broken lines that the telephony device 30 may roam away from access point 50 and therefore is no longer with in WiFi or WiMax coverage. After roaming away from WiFi or WiMax coverage the data connections of telephony device 30 may be handled by base station 46 if base station 46 is configured to handle data connections, e.g., is a Node-B or eNodeB type base station which has a data connection such as GPRS/3G/LTE. As such, being within coverage of Node-B base station 46 the roaming telephony device 30 is able to make a data connection through the licensed frequencies of the base station 46 over the air interface, through appropriate core network nodes such as Serving GPRS Support Node (SGSN) 47 and GPRS Gateway Support Node (GGSN) 49 to internet 24, and through internet 24 to telephony system 20. Thus, although not using the WiFi or unlicensed frequencies, as shown by the dotted-dashed line in FIG. 1 the roamed telephony device 30 still has access through the data services of the macro cell to telephony system 20, and thus remains “in coverage”.

As also shown in FIG. 1, communications system 22 may also comprise a push notification service or push notification server 51. The push notification service 51 is shown as being coupled to the Internet 24, which allows the push notification service 51 to send remote push communications to the mobile telephony device 30. The remote push communications could be sent to the mobile telephony device 30 via the Internet 24, or via a path that includes the Internet 24 and the a cellular data network (e.g., radio access networks 42). In alternate embodiments, the push notification service 51 may communicate directly with the cellular network (e.g., radio access networks 42) in order to cause push notifications to be delivered to mobile telephony device 30.

The telephony device 30 of FIG. 1 provides pre-unlock local push notifications for a non-native telephony service. In an example embodiment and mode such pre-unlock local push interaction is facilitated by processor 52. As used herein, a “local” push notification is a push notification that is generated at the telephony device 30, e.g., by processor 52 when executing instructions stored at telephony device 30, and this is in contrast to a remote push communication (e.g., a remote push notification) which is generated externally to the telephony device 30, e.g., generated by a network (such as push notification service 51).

In an example implementation the processor 52 may work in conjunction with, e.g., execute instructions of, a client software executable application herein known as “CoIP application” 53, as described hereinafter. In view of the fact that the CoIP application 53 may be provided by or in conjunction with the telephony service 20, the CoIP application 53 is characterized as an “over the top” (“OTT”) or non-native executable application.

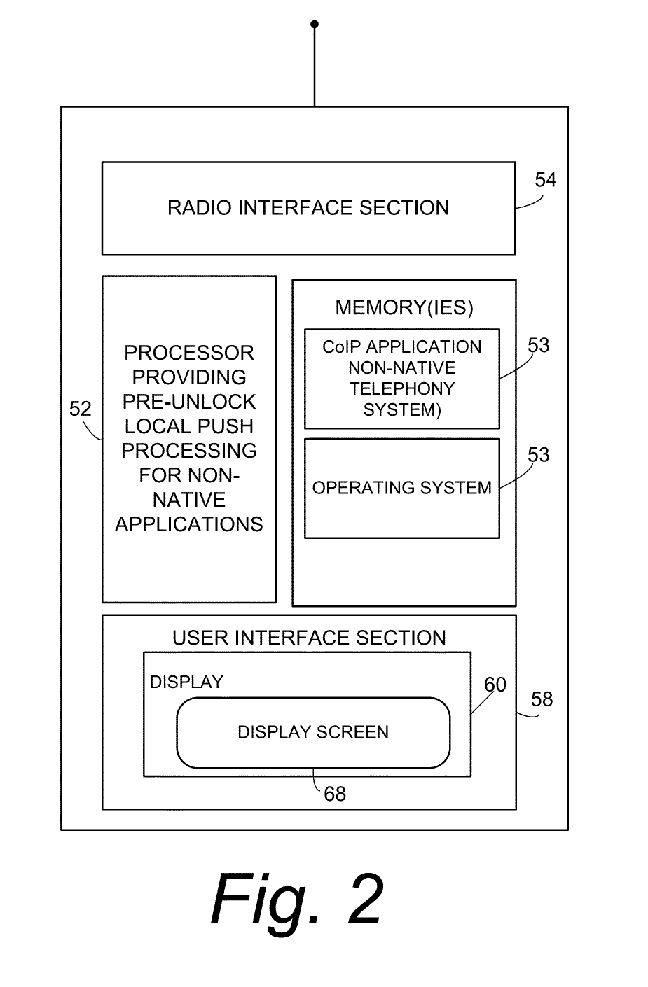

FIG. 2 shows an example generic telephony device 30 comprising processor 52. In addition to processor 52, telephony device 30 also comprises radio interface section 54, memory(ies) 56, and user interface 58.

Radio frequency section 54, also known as a radio frequency interface, is configured to enable telephony device 30 to communicate over radio frequencies, e.g., over an air or radio interface, with an appropriate communication node. As understood from FIG. 1, in some situations the communication node may be the wireless access point 50 through which the telephony device 30 participates in WiFi or WiMax type data communications, as a link in overall data communications with the IP telephony service 20. In other situations also understood from FIG. 1 the communication node may be a macro base station 46 through which the telephony device 30 participates in GPRS-type communications, as a link in overall data communications with the IP telephony service 20. The person skilled in the art will understand that radio frequency section 54 therefore includes appropriate transmitter(s) and receiver(s), as well as antenna(s), as well as radio frequency processing circuitry for pre-processing or post-processing of signals applied to or received from such transmitter(s) and receiver(s).

The memory(ies) 56 may comprise one or more different types of non-transient memories, including random access memory (RAM) and read only memory (ROM). As mentioned above, memory(ies) 56 may have stored therein instructions, in the form of programs or systems, which are executed by processor 52. In other words, the programs or systems stored in memory(ies) 56 are, at appropriate times, loaded into instruction registers or the like of processor 52 and are executed by processor 52. For example, an operating system 55 is stored in memory(ies) 56 and executed by processor 52. The CoIP application 53 is also executed by processor 52.

The user interface 58 may comprise one or more different types of interface devices, and includes interface devices that are configured to facilitate interaction with a user. Among the interface devices that may comprise user interface 58 are display/touch screen 60, audible output device 62 (speaker), tactile output device (e.g., haptic device) 64, and microphone 66 (see FIG. 4) The display/touch screen 60 comprises display screen 68.

As used herein, “display screen” refers to a portion of a display device on which content may be displayed, e.g., to the actual area of a display device wherein pixels or driven illustration elements are located and are visible. A “screen display”, on the other hand, refers to content that is actually rendered on the display screen as a result of execution of instructions that generate the screen display.

The processor 52 may comprise one or more processor(s) or controller(s) as elaborated herein and discussed further with respect to FIG. 7. The processor 52 executes various sets of instructions stored on non-transient computer-readable media. These sets of instructions may be stored in memory(ies) 56. One of the sets of instructions comprises operating system for telephony device 30 described in greater detail below. Other of the sets of instructions may comprise software programs, at least some of which are in the form of computerized executable applications (“apps”).

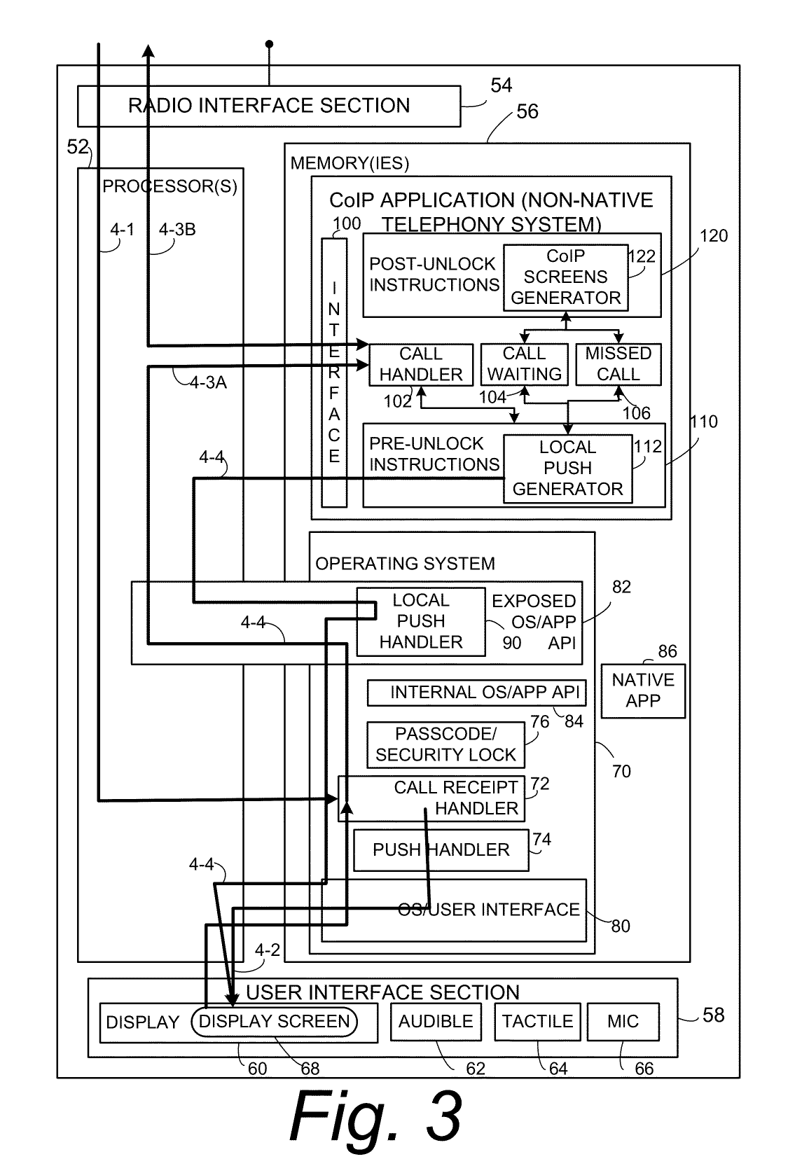

One such executable application may be an application provided by or designed to work in conjunction with communications sent or received by or routed through a non-native telephony network, such as internet-based telephony system 20, and thus may generically be termed a “network application” installed on the telephony device. In view of the fact that the communications encompassed by the technology described herein are not limited to voice communications, the internet-based telephony system 20 may also be referred to as a “Communication over IP”, or “CoIP system”, and its network application executed by processor 52 of telephony device 30 may be referred to as the aforementioned “CoIP application” 53. As such, “CoIP” comprises but it not limited to VoIP communications. The CoIP application 53 may take the form of a computer software product comprising instructions stored on a non-transient memory which, when executed by processor 52 of telephony device 30, result in performance of the acts herein described (see, e.g., FIG. 3 and the acts of FIG. 4).

Although the operating system for telephony device 30 comprises many aspects, only those pertinent to the technology disclosed herein are specifically discussed herein. An exemplary operating system 70 is shown by way of example in FIG. 3 as comprising several units or functionalities, and several interfaces. For example, operating system 70 comprises call receipt handler 72; push handler 74; and passcode/security lock handler 76.

Among the interface which comprise operating system 70 are operating system/user interface 80 and application programmable interfaces (API) 82 and 84. The API 82 is an “exposed” application programmable interface. In other words, exposed application programmable interface (API) 82 is an interface through which a third party executable application, e.g., an executable application that is non-native to operating system 70, such as CoIP application 53, may interact with the operating system 70 and thus through operating system/user interface 80 to user interface 58.

The application programmable interface (API) 84 is an “internal” application programmable interface, meaning that internal application programmable interface (API) 84 is an interface through which only native executable applications may have access for interaction with the operating system 70. One such native executable application is shown as native executable application 86, which may be (for example) a native executable application for a native telephony service.

As mentioned previously, some operating systems configure internal application programmable interface (API) 84 such that the native executable application 86 may essentially fully provide its services including one or more of its library of display screens before unlock of the telephony device, e.g., before removal of the security lock. In such situation the operating system guards security of the telephony device in the sense that, upon exiting the native executable application 86, the lock screen is again displayed on display screen 68. But the non-native executable application such as CoIP application 53, not having access to internal application programmable interface (API) 84 but instead having access to exposed application programmable interface (API) 82, has no such special pre-unlock privilege. Moreover, heretofore it has been necessary to remove the security lock, e.g., to enter the passcode, before the CoIP application 53 can even be used to answer or initiate a telephone call.

The operating system 70 of FIG. 3 comprises a local push handler 90 in its exposed application programmable interface (API) 82. The local push handler 90 enables at least portions of a non-native executable application such as CoIP application 53 to execute prior to removal of the security lock. Moreover, local push handler 90 enables a non-native executable application such as CoIP application 53 to interact with a user via user interface 58 using local push notifications. Such local push handler 90 is understood with reference to the Apple iOS8 operating system.

FIG. 3 further shows CoIP application 53 as comprising interface 100 (which is an interface to operating system 70); call handler 102; call waiting handler 104; and missed call handler 106. In addition, CoIP application 53 comprises several set of instructions whose execution is dependent on whether the passcode/security lock handler 76 has determined the telephony device to be locked or unlocked. In this regard, CoIP application 53 comprises a set of instructions which may be executed by processor 52 prior to removal of the security lock, e.g., pre-unlock instructions 110. The pre-unlock instructions 110 comprise, among other things, instructions for generating local push notifications, e.g., local push generator 112. The CoIP application 53 also comprises a set of instructions which may be executed by processor 52 after removal of the security lock, e.g., post-unlock instructions 120. The post-lock instructions 120 comprise, among other things, instructions (e.g., CoIP screen generator 122) for generating CoIP display screens, e.g., full screen displays through which the CoIP application 53 may communicate with a user over user interface 58.

Before describing operation of processor 52, use and implementation of push notification service 51 is described in basic terms. In general, a push notification service 51 allows an application such as CoIP application 53 that is installed on a telephony device 30 to complete a registration process that results in CoIP application 53 receiving a device token. The device token uniquely identifies the telephony device 30. The CoIP application 53 on the telephony device 30 then provides this token to the service provider that created the application (e.g., telephony system 20) on the telephony device 30. Once the telephony system 20 has possession of the token associated with the telephony device 30, the telephony system 20 can cause the push notification service 51 to send push notifications to the telephony device 30. A request for a push notification that is sent from the telephony system 20 to the push notification service 51 would include the device token, and information about the type of push notification that is to be sent to the telephony device 30. When the push notification service 51 receives a push notification request from telephony system 20, push notification service 51 uses the information in the request to create a formatted push notification that it then delivers to telephony device 30. The push notification can cause the telephony device 30 to take several different actions. For example, a push notification can cause telephony device 30 to update a number displayed on a badge associated with CoIP application 53. The number usually indicates that new information is available to CoIP application 53, and the number may indicate the quantity of the new information. When a user sees a number on an application badge, the user can press the badge to load and run the application (e.g., CoIP application 53), which usually results in the CoIP application 53 requesting and obtaining the new information that is waiting. A push notification can also cause a notification message to be displayed on telephony device 30. The notification message will usually include two buttons that the user can press. One button, usually labeled as “DISMISS,” allows the user to dismiss the notification message. If the user presses this button, the notification message will no longer be displayed, and no further action will be taken by the mobile device. However, if the user pushes the other button, which is usually labeled as “VIEW,” telephony device 30 will normally load and run the application (e.g., CoIP application 53) on telephony device 30. See, e.g., U.S. patent application Ser. No. 13/940,647, filed Jul. 12, 2013, entitled “Method and Apparatus for VoIP Communication Completion to a Mobile Device”, and U.S. patent application Ser. No. 13/940,804, filed Jul. 12, 2013, entitled “Method and Apparatus for VoIP Communication Completion to a Mobile Device”, both of which are incorporated herein by reference in their entirety.

FIG. 4 shows example, representative, non-limiting basic acts or steps that may be executed by telephony device 30 according to an example embodiment and mode of the technology disclosed herein. Act 4-1 comprises the telephony device 30 receiving from a network a notification of an incoming call carried by a non-native telephony service. Act 4-2 comprises the processor 52, in conjunction with the incoming call, providing a push notification on a user interface (e.g., on display/touch screen 60) while the telephony device is subject to a security lock. The push notification is configured to prompt a first user response input through the user interface. Act 4-3 comprises, upon receipt of the first user response input, completing a telephony connection carried by the non-native telephony service while the telephony device is still subject to the security lock. Act 4-4, an optional but typically utilized act, comprises the processor 52 generating a local push notification to be displayed on the user interface while the telephony device is still subject to the security lock. The acts of FIG. 4 are described in example fashion in more detail below, at times with reference to FIG. 3.

The act (act 4-1) of the telephony device 30 receiving notification of an incoming call carried by a non-native telephony service may occur in several ways. For example, when a network directs a call to telephony device 30, the call may be routed from the network to the telephony device 30 by direct signaling (such as a network event) or by a remote push communication (e.g., APNS on Apple or GCM on Google). The notification of the incoming call is processed by call receipt handler 72 of operating system 70, as reflected by arrow 4-1 of FIG. 3.

Act 4-2 comprises the processor 52, in conjunction with the incoming call, providing a push notification on display screen 68 of user interface 58 while the telephony device is subject to a security lock. In the case of the notification of the incoming call being a remote push communication, the call receipt handler 72 automatically provides the remote push notification to user interface 58. In the case of the notification of the incoming call being a network event, the call receipt handler 72 causes push handler 74 to generate a local push notification which serves as the push notification of act 4-2. Thus, either by the remote push or the local push generated by the network event, the user receives an initial push notification on display screen 68 of user interface 58. FIG. 3 shows this initial push notification of act 4-2 as being generated by call receipt handler 72 and being processed by push handler 74 and through operating system/user interface 80 for display of the push notification (whether remote or local) on display screen 68 of user interface 58 (see arrow 4-2 in FIG. 3).

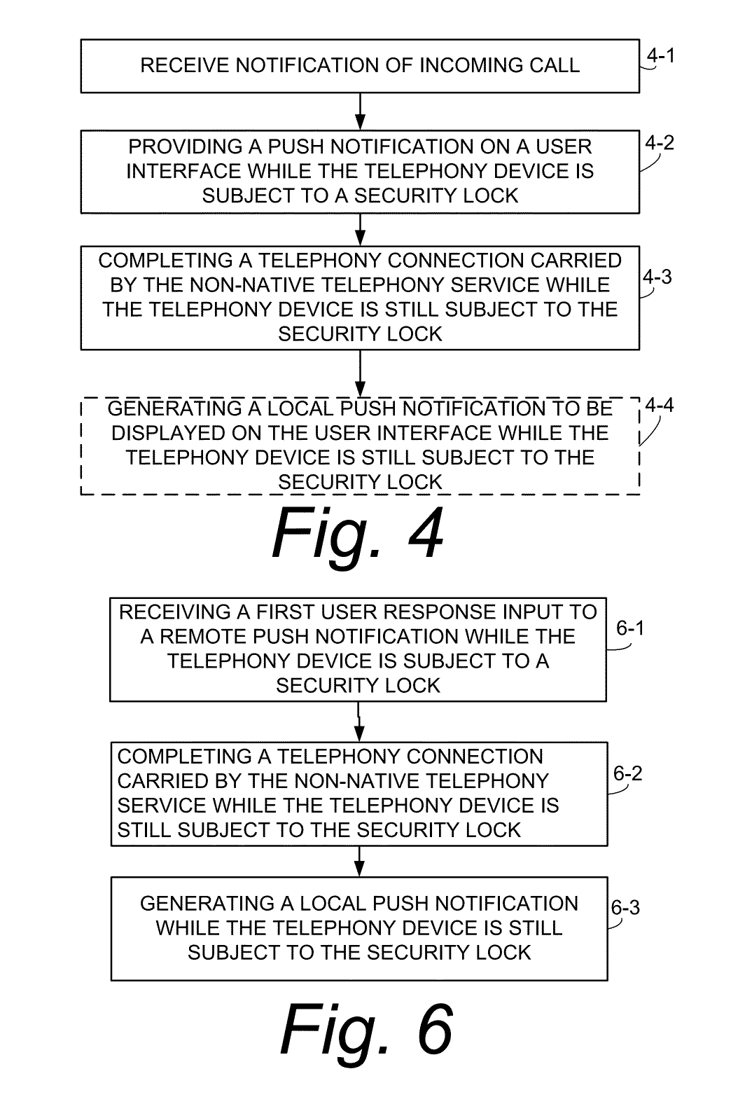

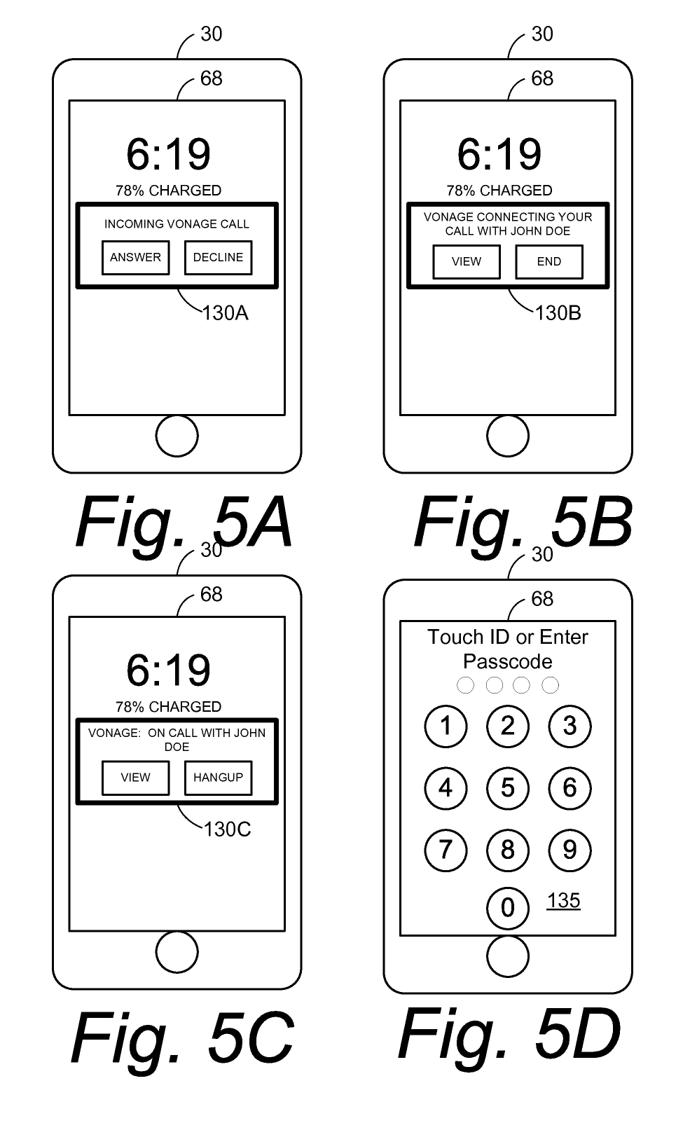

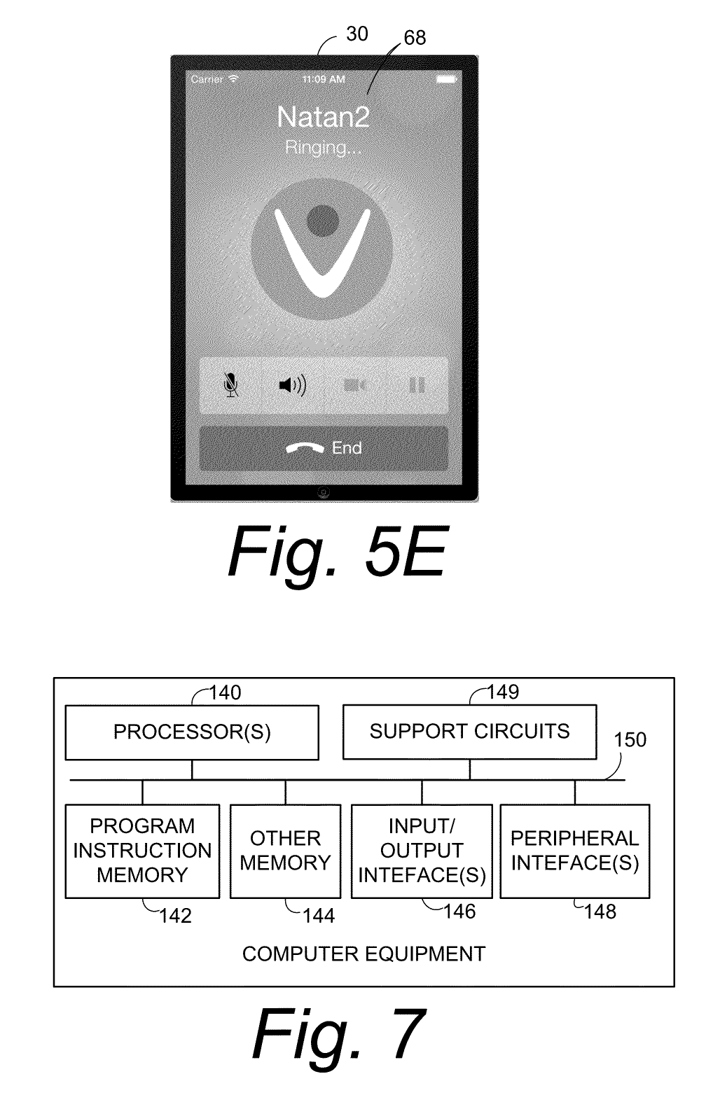

The initial push notification of act 4-2 is configured to prompt a first user response input through the user interface 58. As shown by the example screen display of FIG. 5A, such initial push notification 130A of act 4-2 may invite a response input of “Answer” (the first user response) or response input of “Decline”.

As used herein, any push notification, whether remote or local, visually occupies a minor portion of the display screen 68. By “minor” portion is meant less than half of the available pixel or other display element footprint of the display/touch screen 60. A push notification is thus in contrast to a screen display, which may be generated by an executable application such as CoIP application 53 after release of the security lock. A screen display may visually occupy essentially the entire available pixel or other display element footprint of the display/touch screen 60. But it will be recalled that, prior to removal of the security lock, a non-native executable application such as CoIP application 53 is not permitted to send any of its screen displays to user interface 58.

Act 4-3 comprises the processor 52, upon receipt of the first user response input, completing a telephony connection carried by the non-native telephony service while the telephony device is still subject to the security lock. That is, assuming that the user responds to the initial push notification 130 of act 4-2 with an “Answer” response input, such “Answer” response input is communicated by user interface 58 via operating system/user interface 80 to call receipt handler 72, and call receipt handler 72 calls or invokes execution of CoIP application 53, even though the security lock has not been released. Such call or invocation of CoIP application 53 is indicated by arrow 4-3A of FIG. 3, and actual completion of the call over non-native telephony service (e.g., Internet telephony service) is depicted by arrow 4-3B of FIG. 3.

It should be understood that in some situations the CoIP application 53 may already be executing on processor 52 when an incoming call is received, e.g., the CoIP application 53 may be processing another call or executing in the background. In other situations the CoIP application 53 may not be executing. In either situation, the technology disclosed herein concerns the case when an incoming call is received when the telephony device 30 is locked, and hence the CoIP application 53 cannot interact with the user using the screen displays of the CoIP application 53.

The technology disclosed herein does, however, afford the CoIP application 53 the opportunity to interact with the user by employing one or more local push notifications. As mentioned in conjunction with act 4-2, when executing the CoIP application 53 as a result of a user “Answer” the processor 52 may invoke act 4-4 to generate a local push notification to be displayed on the user interface while the telephony device is still subject to the security lock. In particular, in an example embodiment and mode upon completion of the call (act 4-2) the call handler 102 prompts the local push generator 112 to send a local push through the exposed application programmable interface (API) 82 and through operating system/user interface 80 to user interface 58, as depicted by arrow 4-4. The local push handler 90 of exposed application programmable interface (API) 82 processes the local push notification generated by local push generator 112, and directs transmission of the local push notification through operating system/user interface 80 to the display screen 68 of user interface 58.

A first example of a local push notification 130B of act 4-4 is depicted in FIG. 5B. The local push notification 130B informs the user that the non-native telephony service is connecting the call with a party (whose name may be displayed in the local push notification 130B). The local push notification of act 4-4 may also be configured to prompt a further user response input through the user interface 58. As shown by the example screen display of FIG. 5B, the example local push notification 130B of act 4-4 may invite a response input of “View” (the further user response) or a response input of “End”.

A second example of a local push notification 130C of act 4-4 is depicted in FIG. 5C. The local push notification 130C informs the user that the non-native telephony service has connected the call with a party (whose name may be displayed in the local push notification 130C). As shown by the example screen display of FIG. 5C, the example local push notification 130C of act 4-4 may invite a response input of “View” or a response input of “Hang Up”.

During the time that telephony device 30 is subject to the security lock, e.g., before entry of the passcode, upon receipt and answering of an incoming call the user will be able to participate in the call carried by the non-native executable application (e.g., CoIP application 53). In so doing the CoIP application 53 executes the pre-unlock instructions 110 and may interact with the user through the local push notifications which are generated by local push generator 112. At this time, before removal of the security lock, the CoIP application 53, while executing on the processor 52, is not visibly launched in the sense that the post-unlock instructions 120 are not executed, and the CoIP application 53 cannot invoke CoIP screen generator 122 to generate the traditional screen displays of the CoIP application 53.

If the user were to enter a response input of “View” as the further user response to either local push notification 130B of FIG. 5B or to local push notification 130C of FIG. 5C, a lock screen 135 such as that of FIG. 5D would appear. The lock screen provides the user with an opportunity to enter a passcode or other user identification for removing the security lock. When the correct passcode or other security information is entered, the passcode/security lock handler 76 removes the lock screen 135 and allows the non-native executable application (e.g., CoIP application 53) to execute fully, e.g., to execute the post-unlock instructions 120. When executing the post-unlock instructions 120, the CoIP application 53 is able to invoke CoIP screen generator 122 as appropriate, thereby providing one or more screen displays associated with execution of the non-native executable application. The information for the screen displays generated by CoIP screen generator 122 is transmitted through the exposed application programmable interface (API) 82 and operating system/user interface 80 to user interface 58 for display to the user. A non-limiting example of such a screen display is illustrated in FIG. 5E.

The CoIP application 53 may generate many different types of local push notifications. For example, local push generator 112 may generate a local push notification that advises, while a first call is connected, that another call is waiting. In this regard, the local push generator 112 upon receiving another call the call waiting handler 104 may prompt local push generator 112 to generate a call waiting local push notification. Another type of local push notification is for a missed call. If a call is missed, the missed call handler 106 prompts local push generator 112 to generate a missed call local push notification. Both the call waiting local push notification and the missed call local push notification are routed through local push handler 90 of operating system/user interface 80 and through operating system/user interface 80 to the display screen 68 of user interface 58.

FIG. 4 shows that, in an example embodiment and mode, CoIP application 53 comprises both pre-unlock instructions 110 and post-unlock instructions 120. The pre-unlock instructions 110 comprise local push generator 112 which is configured, when executed by processor 52, to generate one or more local push notifications while the telephony device is still subject to the security lock. The post-unlock instructions 120 employ CoIP screen generator 122 as needed to provide full screen displays to user interface 58.

Thus, processor 52 executes operating system 70 and a non-native telephony service executable application such as CoIP application 53. The operating system 70 and the non-native telephony service executable application comprise respective executable instructions stored on a non-transient computer-readable medium. The operating system comprises operating system/user interface 80 through which a remote push notification (and a native telephony service application 86) have access to the user interface 58; and exposed application programmable interface (API) 82 through which the non-native telephony service executable application (e.g., 53) has non-direct access to the user interface 58. The non-native telephony service executable application comprises a set of pre-unlock coded instructions 110 configured to generate, through the operating system/application interface 82 and then through the operating system/user interface 80, one or more local push notifications on the user interface 58 while the telephony device is still subject to the security lock.

Whereas a local push notification visually occupies a minor portion of the display screen 68, the one or more screen displays associated with the execution of the non-native telephony service executable application visually occupy a preponderance of the display screen 68.

FIG. 6 shows acts which may be performed upon execution by processor 52 of coded instructions comprising a computer program product which serves as CoIP application 53. The instructions are stored on a non-transient memory which, when executed by a processor of telephony device 30, result in performance of acts of FIG. 6. Act 6-1 comprises receiving an indication from an operating system of the telephony device of receipt of a first user response input to a push notification provided on a user interface of the telephony device while the telephony device is subject to a security lock. Act 6-2 comprises, in accordance therewith receipt of the first user response input, completing a telephony connection carried by the non-native telephony service while the telephony device is still subject to the security lock. Act 6-3 comprises generating a local push notification to be displayed on the user interface while the telephony device is still subject to the security lock.

Functions described herein, including the CoIP application 53 of wireless telephony device 30 may, at least in some embodiments and modes, be performed by machine hardware. FIG. 7 shows an example of such machine hardware as comprising one or more processors 140 (which may be or comprise processor 52 of telephony device 30); memory such as program instruction memory 142 and other memory 144 (e.g., RAM, cache, etc.), which may comprise memory(ies) 56; input/output interfaces 146 (which may include user interface 58); peripheral interfaces 148; support circuits 149; and busses 150 for communication between the aforementioned units.

The memory(ies) 56, or computer-readable medium, may be one or more of readily available memory such as random access memory (RAM), read only memory (ROM), floppy disk, hard disk, flash memory or any other form of digital storage, local or remote, and is preferably of non-volatile nature. The support circuits 159 are coupled to the processors 140 for supporting the processor in a conventional manner. These circuits include cache, power supplies, clock circuits, input/output circuitry and subsystems, and the like.

Software routines such as software for CoIP application 53 of wireless telephony device 30 may be computer program products which include coded instructions stored on non-transient medium and which are executed by processors 140/52 of wireless telephony device 30 for performing the acts described herein. For the machine hardware of wireless telephony device 30 such software/computer program products may be stored on non-transient memory such as program instruction memory 142. Such software, when executed by processors 140, transforms the general purpose computer into a specific purpose computer that performs one or more functions of telephony device 30. Although the processes of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routines of the disclosed embodiments are capable of being executed on any computer operating system, and is capable of being performed using any CPU architecture.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the exemplary hardware recited above.

The technology disclosed herein may be used in conjunction with caller ID services, such as those described in U.S. patent application Ser. No. 14/456,820, filed Aug. 11, 2014, and entitled “ ON-BOARD HANDLING OF CALLER IDENTIFICATION FOR WIRELESS TELEPHONY DEVICE”, which is incorporated herein by reference in its entirety.

The technology disclosed herein addresses a prior art problem by connecting an incoming call carried by a non-native telephony service without fully launching the executable application of the non-native telephony service, and thus avoiding the passcode entry or having to unlock the telephony device 30.

The technology disclosed herein enables a non-native executable application such as CoIP application 53 to provide a quick message, e.g., a local push notification, to the user on top of the lock screen. If a major action is subsequently required on part of the user, the user may open the executable application.

Although the description above contains many specificities, these should providing illustrations of some of the presently preferred embodiments of the technology disclosed herein. Thus the scope of the technology disclosed herein should be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A telephony device comprising:
a user interface;
a processor configured:
to generate, on the user interface, plural user interface displays which provide user output information and through which user input is received by the processor;
to provide a push notification to be displayed on the user interface upon receipt of an indication of an incoming telephony event carried by a non-native telephony service and while the telephony device is subject to a security lock, the push notification being configured to prompt a first user response input through the user interface;
upon receipt of an appropriate first user response input, to complete a telephony connection carried by the non-native telephony service while the telephony device is still subject to the security lock.

2. The telephony device of claim 1, wherein the processor is further configured to generate the push notification as a local push notification to be displayed on the user interface while the telephony device is still subject to the security lock.

3. The telephony device of claim 2, wherein the user interface comprises a display screen, and wherein the local push notification visually occupies a minor portion of the display screen.

4. The telephony device of claim 2, wherein the local push notification is configured to facilitate entry of further user input response while the telephony device is still subject to the security lock.

5. The telephony device of claim 1, wherein the processor is configured upon receipt of the appropriate first user response input to execute pre-unlock coded instructions comprising a non-native telephony service executable application, the pre-unlock instructions being configured to generate said local push notification.

6. A method in a telephony device comprising:
receiving from a network a notification of an incoming call carried by a non-native telephony service;
in conjunction with the incoming call providing a push notification on a user interface while the telephony device is subject to a security lock, the push notification being configured to prompt a first user response input through the user interface;
upon receipt of an appropriate first user response input, completing a telephony connection carried by the non-native telephony service while the telephony device is still subject to the security lock.

7. The method of claim 6, further comprising generating the push notification as a local push notification to be displayed on the user interface while the telephony device is still subject to the security lock.

8. The method of claim 7, wherein the user interface comprises a display screen, and wherein the local push notification visually occupies a minor portion of the display screen.

9. The method of claim 7, further comprising configuring the local push notification to provide one of a call waiting notification and a missed call notification.

10. The method of claim 7, further comprising receiving a further user input response local push notification while the telephony device is still subject to the security lock.

11. The method of claim 10, further comprising upon receipt of the first user response input, generating one or more local push notifications while the telephony device is still subject to the security lock.

12. The method of claim 7, further comprising:
executing an operating system and a non-native telephony service executable application using a processor, the operating system and the non-native telephony service executable application comprising respective executable instructions stored on a non-transient computer-readable medium;
the operating system providing direct access to the user interface for the remote push notification and a native telephony service application;
the operating system providing non-direct access for the non-native telephony service executable application to the user interface through an operating system/application interface;
the non-native telephony service executable application generating or more local push notifications on the user interface using the operating system/application interface while the telephony device is still subject to the security lock.

13. The method of claim 7, further comprising displaying the local push notification on a display screen of the user interface over a minor portion of a screen display generated by the operating system.

14. The method of claim 12, further comprising:
receiving an unlock user entry; and then
the non-native telephony service executable application executing a set of post-unlock coded instructions configured to generate, through the application interface and through the operating system interface, one or more screen displays associated with execution of the non-native telephony service executable application while the telephony device is not subject to the security lock.

15. The method of claim 14, wherein the user interface comprises a display screen, wherein the local push notification visually occupies a minor portion of the display screen; and wherein the one or more screen displays associated with the execution of the non-native telephony service executable application visually occupy a preponderance of the display screen.

16. A computer program product comprising instructions stored on a non-transient memory which, when executed by a processor of a telephony device, result in performance of the following acts:
receiving an indication from an operating system of the telephony device of receipt of a first user response input to a push notification provided on a user interface of the telephony device while the telephony device is subject to a security lock; and in accordance therewith
completing a telephony connection carried by the non-native telephony service while the telephony device is still subject to the security lock.

17. The computer program product of claim 16, comprising instructions stored on the non-transient memory which, when executed by the processor of the telephony device, generate the push notification as a local push notification to be displayed on the user interface while the telephony device is still subject to the security lock.

18. The computer program product of claim 17, wherein the user interface comprises a display screen, and wherein the local push notification visually occupies a minor portion of the display screen.

19. The computer program product of claim 17, comprising instructions stored on the non-transient memory which, when executed by the processor of the telephony device, configure the local push notification as one of a call waiting notification and a missed call notification.

20. The computer program product of claim 17, comprising instructions stored on the non-transient memory which, when executed by the processor of the telephony device, configure the local push notification to facilitate entry of further user input response while the telephony device is still subject to the security lock.

21. The computer program product of claim 17, further comprising instructions stored on the non-transient memory which, when executed by the processor of the telephony device, generate, through an operating system/application interface and then through an operating system/user interface, one or more local push notifications on the user interface while the telephony device is still subject to the security lock.

22. The computer program product of claim 17, further comprising instructions stored on the non-transient memory which, when executed by the processor of the telephony device, display the local push notification on a display screen of the user interface over a minor portion of a screen display generated by the operating system.

23. The computer program product of claim 17, further comprising a set of post-unlock coded instructions stored on the non-transient memory which, when executed by the processor of the telephony device, generate, through an operating system/application interface and through an operating system/user interface, one or more screen displays associated with execution of the non-native telephony service executable application while the telephony device is not subject to the security lock.

24. The computer program product of claim 17, wherein the user interface comprises a display screen, wherein the local push notification visually occupies a minor portion of the display screen; and wherein the one or more screen displays associated with the execution of the non-native telephony service executable application visually occupy a preponderance of the display screen.
